(19) United States
(12) Patent Application Publication
(10) Pub. No.: US 2013/0339530 A1
(43) Pub. Date: Dec. 19, 2013

(54) SHARED BANDWIDTH CONTROL METHOD AND DEVICE IN BANDWIDTH SHARING NETWORK AMONG USER GROUPS, AND SHARED BANDWIDTH CONTROL SYSTEM

(71) Applicant: Itaru Nishioka, Tokyo (JP)

(72) Inventor: Itaru Nishioka, Tokyo (JP)

(73) Assignee: NEC Corporation, Minato-ku, Tokyo (JP)

(21) Appl. No.: 13/990,681

(22) PCT Filed: Oct. 28, 2011
(86) PCT No.: PCT/JP2011/006040

§ 371 Date: Aug. 19, 2013

(30) Foreign Application Priority Data
Nov. 30, 2010 (JP) 2010-265927

(51) Int. Cl. H04L 12/24; H04L 12/911

(52) U.S. Cl. CPC H04L 41/5019; H04L 47/78
USPC 709/226

(57) ABSTRACT

A shared bandwidth control method, device, and system are provided that can accommodate burst traffic between multiple locations and enhance usage efficiency of a communication link without performing complicated control. In a bandwidth sharing network 100 in which a plurality of user groups G1 to G4 share network resources through a plurality of locations, a traffic acquisition section acquires user traffic transmission volumes flowing from the respective locations into the bandwidth sharing network, and a scheduler regulates a user traffic transmission volume flowing into the bandwidth sharing network so that a total of the user traffic transmission volumes will not exceed a total bandwidth pre-assigned to the plurality of user groups in the bandwidth sharing network.

### TECHNICAL FIELD

The present invention relates to a shared bandwidth control method, device, and system in an intra-groups bandwidth sharing network in which a plurality of users share network resources.

### BACKGROUND ART

Conventionally, a user who is to receive an intercommunication service through a communication network, in general, adds up communication traffic volumes of various applications to be used by the user and, based on the value of this addition, makes an agreement on a bandwidth for use with a communication service provider.

For example, an enterprise having a plurality of business bases, estimates communication traffic volumes between each pair of bases and uses a dedicated line service or VPN (Virtual Private Network) service of a communication service provider. Moreover, dedicated line services and VPN services are also used for enterprises and organizations running a plurality of data centers to connect such data centers. In the dedicated line service, a quality assured service can be received because of dedicatedly secured communication resources, but a charge for the communication service is generally high. On the other hand, VPN has the characteristic of lower costs because communication resources shared with other users can be used as if they were of a dedicated line. Examples of VPN include IP-VPN, L2VPN (Layer-2 VPN), L1VPN (Layer-1 PVN), and the like.

In VPN, communication quality may be degraded in comparison with a dedicated line because communication resources are shared with other users. However, communication quality can be maintained by making a design in expectation of the effect of statistical multiplexing on traffic between a plurality of users, or by setting an upper limit to traffic volumes in an agreement with a user. Moreover, according to a QoS control method disclosed in PTL 1, a QoS (Quality of Service) server managing the communication quality of a communication network restricts transmission bandwidths of other communication devices sharing a communication route in question so that end-to-end communication quality required by a user will be assured.

### CITATION LIST

### Patent Literature

[PTL 1]

Japanese Patent Application Unexamined Publication No. 2003-218929

### SUMMARY OF INVENTION

### Technical Problem

However, in the method of setting an upper limit to a bandwidth in an agreement with a user, even when there is an available bandwidth in a communication link, traffic is discarded by a traffic shaper of a communication network upon the user's excess over the agreed bandwidth, which means that burst traffic cannot be transmitted, decreasing usage efficiency of the communication link. Moreover, even if the effect of statistical multiplexing on traffic between users is considered, the usage rate of a communication link is very low in most cases because a peak bandwidth agreed with each user needs to be assured.

In the method disclosed in PTL 1, end-to-end control is complicated because to perform control of communication quality, QoS control needs to be performed on all communication devices in a communication network. Further, in communication across communication networks of different providers, it is also problematic that quality required by a user cannot be met because QoS provision varies with the carrier or depends on the performance of an installed communication device or the like.

Accordingly, an object of the present invention is to provide a shared bandwidth control method, device, and system that can accommodate burst traffic between multiple locations and enhance usage efficiency of a communication link, without performing complicated control, in an intra-groups bandwidth sharing network in which a plurality of users share network resources.

### Solution to Problem

A shared bandwidth control method according to the present invention is a shared bandwidth control method in a bandwidth sharing network in which a plurality of user groups share network resources through a plurality of locations, characterized in that traffic acquisition means acquires user traffic transmission volumes flowing from the respective locations into the bandwidth sharing network; and a scheduling means regulates a user traffic transmission volume flowing into the bandwidth sharing network so that a total of the user traffic transmission volumes will not exceed a total bandwidth pre-assigned to the plurality of user groups in the bandwidth sharing network.

A shared bandwidth control device according to the present invention is a shared bandwidth control device in a bandwidth sharing network in which a plurality of user groups share network resources through a plurality of locations, characterized by comprising: traffic acquisition means for acquiring user traffic transmission volumes flowing from the respective locations into the bandwidth sharing network; and scheduling means for regulating a user traffic transmission volume flowing into the bandwidth sharing network so that a total of the user traffic transmission volumes will not exceed a total bandwidth pre-assigned to the plurality of user groups in the bandwidth sharing network.

A shared bandwidth control system according to the present invention is a shared bandwidth control system in a bandwidth sharing network in which a plurality of user groups share network resources through a plurality of locations, characterized by comprising: bandwidth control devices that are provided respectively at the plurality of locations of the bandwidth sharing network and perform monitoring of a traffic volume of each user and bandwidth control; and a shared bandwidth control device that can communicate with each of the bandwidth control devices, wherein the shared bandwidth control device comprises: traffic acquisition means for acquiring user traffic transmission volumes flowing from the respective bandwidth control devices into the bandwidth sharing network; and scheduling means for regulating a user traffic transmission volume flowing into the bandwidth sharing network so that a total of the user traffic transmission volumes will not exceed a total bandwidth pre-assigned to the plurality of users in the bandwidth sharing network.

### Advantageous Effects of Invention

According to the present invention, it is possible to accommodate burst traffic between multiple locations and enhance usage efficiency of a communication link, without performing complicated control, in an intra-groups bandwidth sharing network in which a plurality of users share network resources.

### BRIEF DESCRIPTION OF DRAWINGS

[FIG. 1]

FIG. 1 is a network diagram showing a schematic structure of a shared bandwidth control system in an intra-user-groups bandwidth sharing network according to an exemplary embodiment of the present invention.

[FIG. 2]

FIG. 2 is a network diagram showing a shared bandwidth control system in an intra-user-groups bandwidth sharing network according to an example of the present invention.

[FIG. 3]

FIG. 3 is a block diagram showing an example of a functional configuration of a bandwidth control device in FIG. 2.

[FIG. 4]

FIG. 4 is a block diagram showing an example of a functional configuration of a shared bandwidth control device in FIG. 2.

[FIG. 5]

FIG. 5 is a block diagram showing an example of a functional configuration of a billing management device in FIG. 2.

[FIG. 6]

FIG. 6 is a flowchart showing a shared bandwidth control procedure according to the present example.

[FIG. 7]

FIG. 7 is a block diagram showing an example of a shared bandwidth control system to which the present example is applied.

[FIG. 8]

FIG. 8(A) is a graph showing changes in traffic volume of each user and changes in total traffic volume when traffic flow volume control according to the application example shown in FIG. 7 is not performed, and FIG. 8(B) is a graph showing changes in traffic volume of each user and changes in total traffic volume when the traffic flow volume control according to the present application example is performed.

[FIG. 9]

FIG. 9 is a graph showing an example of a cost function used for billing management utilizing the shared bandwidth control system according to the present example.

### DESCRIPTION OF EMBODIMENTS

### 1. Exemplary Embodiment

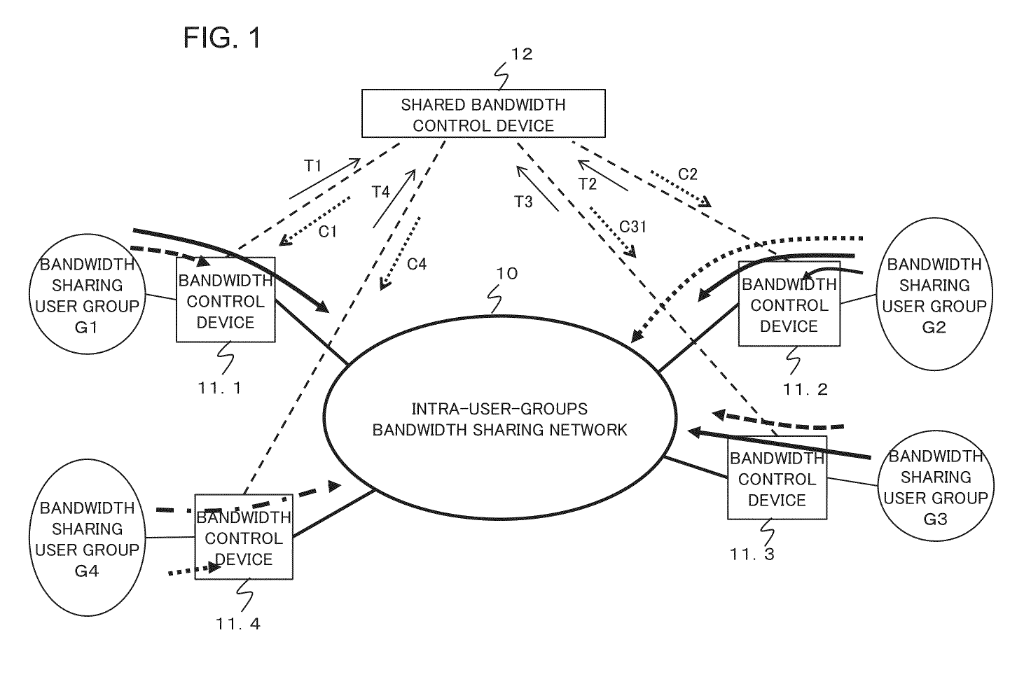

Referring to FIG. 1, assuming that a bandwidth sharing network 10 shared among user groups has four end points (ingresses/egresses), bandwidth control devices 11.1 to 11.4 are provided respectively. User groups G1 to G4 including a plurality of user terminals are connected to the bandwidth sharing network 10 through the bandwidth control devices 11.1 to 11.4 respectively. The plurality of user terminals of the user groups G1 to G4 share a limited network bandwidth of the bandwidth sharing network 10 to transmit burst traffic. This limited network bandwidth is, for example, a maximum bandwidth of the bandwidth sharing network 10, or a total of bandwidths assigned to the user groups. The bandwidth sharing network 10 is, for example, a wide area network (WAN: Wide Area Network) or a virtual private network (VPN: Virtual Private Network) set up over a network of a carrier.

A shared bandwidth control device 12 controls the bandwidth control devices 11.1 to 11.4 provided respectively at multiple locations, to restrict a total traffic volume of the bandwidth sharing network 10 to the limited shared bandwidth. The shared bandwidth control device 12 includes a traffic acquisition section that acquires or estimates transmission traffic volumes T1 to T4 flown from the bandwidth control devices 11.1 to 11.4 respectively to the bandwidth sharing network 10, and a scheduler that regulates traffic flow volumes between users by transmitting schedule signals C1 to C4 to the bandwidth control devices 11.1 to 11.4 respectively so that the total traffic volume will not exceed the shared bandwidth of the bandwidth sharing network 10, which will be described later in detail. For a method of regulating traffic flow volumes, it is preferable that order of transmission be determined in accordance with priority, but other existing methods can also be used concurrently.

Note that if transmission traffic volumes from user devices can be regulated, it is also possible to deploy the bandwidth control devices 11.1 to 11.4 within the user devices in a distributed manner, not at the end points of the bandwidth sharing network 10. Moreover, it is preferable to provide a billing management means for reducing a charge to a user whose transmission traffic volume was decreased, depending on the decrease.

As described above, according to the present exemplary embodiment, the total traffic volume can be easily regulated close to the maximum shared bandwidth of the bandwidth sharing network 10 by controlling traffic at inflow points of multiple locations only.

### 2. Example

Next, an example of the present invention will be described in detail with reference to drawings.

### 2.1) System Structure

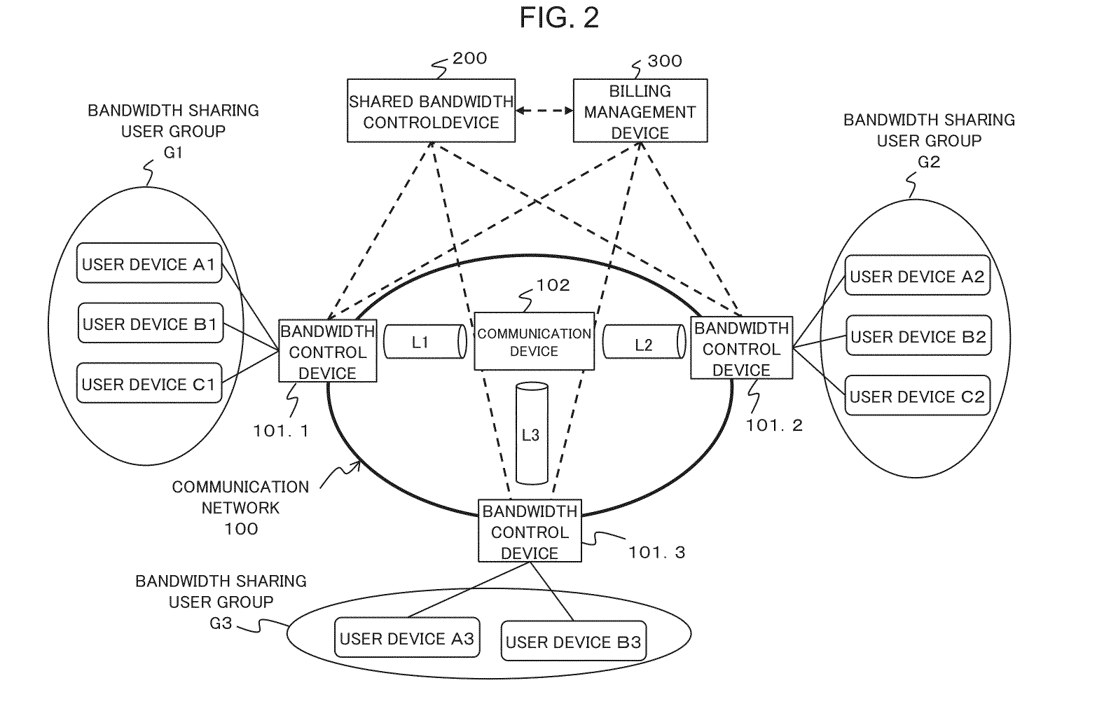

Referring to FIG. 2, it is assumed that a plurality of communication devices are deployed in a communication network 100 of a communication service provider, and that a bandwidth sharing network is built in such manner that a plurality of bandwidth control devices connected to a plurality of user devices are connected to each other through at least one of the communication devices. Here, to simplify the description, shown in the drawing is a structure, as an example, in which three bandwidth control devices 101.1 to 101.3 are connected to a communication device 102 through communication links L1 to L3 respectively. The communication links L1 to L3 may be any of physical links such as optical fiber links and communication channels assigned to user groups over physical links. The communication device 102 is a general router or switch that processes traffic on a packet basis, and therefore a description thereof will be omitted.

A bandwidth sharing user group includes a plurality of user devices that receive communication services through the communication network 100. Here, it is assumed that a bandwidth sharing user group G1 includes user devices A1, B1, and C1 connected to the bandwidth control device 101.1, that a bandwidth sharing user group G2 includes user devices A2, B2, and C2 connected to the bandwidth control device 101.2, and that a bandwidth sharing user group G3 includes user devices A3 and B3 connected to the bandwidth control device 101.3.

Incidentally, the bandwidth control devices 101.1 to 101.3 have the same configuration. Therefore, hereinafter, when an arbitrary bandwidth control device is indicated, it will be expressed as “bandwidth control device 101.i” and a bandwidth sharing user group connected thereto will be expressed as “bandwidth sharing user group Gi.”

A shared bandwidth control device 200, which can be deployed as an independent communication station, regulates a total traffic volume of the bandwidth sharing network by controlling the bandwidth control devices 101.1 to 101.3, as will be described later. A billing management device 300 is responsible for user billing processing according to control by the shared bandwidth control device 200.

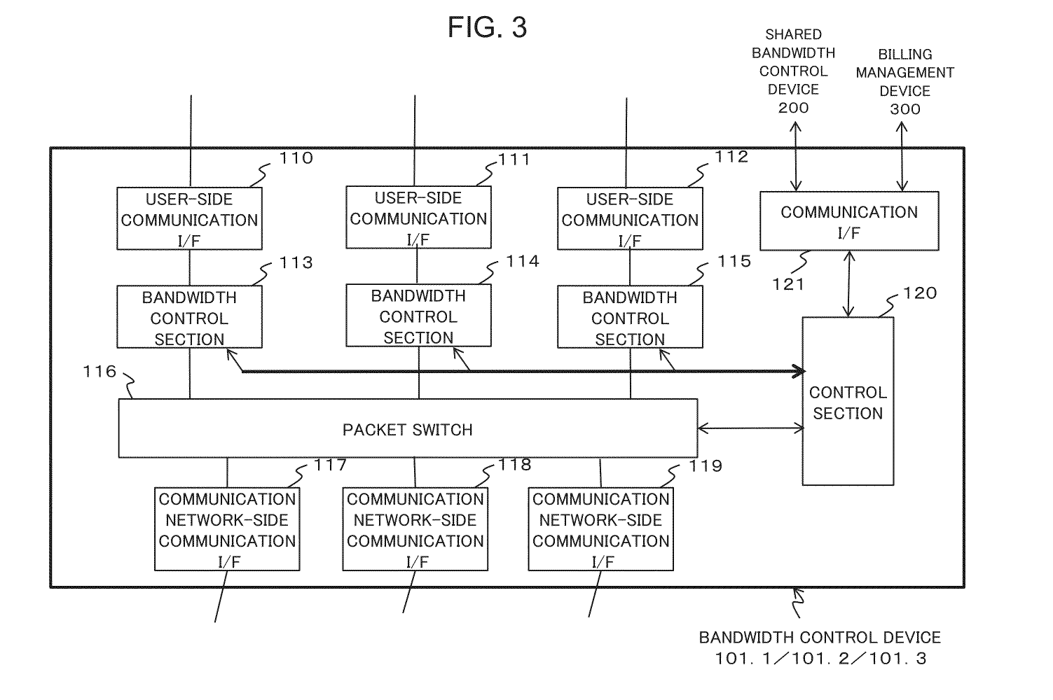

Referring to FIG. 3, the bandwidth control device 101.i has a plurality of interfaces connected respectively to the plurality of user devices of its corresponding user bandwidth sharing user group Gi. Here, it is assumed that the user bandwidth sharing user group Gi includes three user devices, which are connected to communication interfaces 110 to 112 respectively. The communication interfaces 110 to 112 are connected to user-side ports of a packet switch 116 via bandwidth control sections 113 to 115 respectively, and communication interfaces 117 to 119 interfacing with the communication network 100 are connected to communication network-side ports of the packet switch 116. The bandwidth control sections 113 to 115 monitor traffic volumes of respective users and notify them to a control section 120, and also regulate transmission bandwidths of the respective users in accordance with control by the control section 120.

The control section 120 can communicate with the shared bandwidth control device 200 and the billing management device 300 through a communication interface 121. The control section 120 receives a schedule signal from the shared bandwidth control device 200 and controls the bandwidth control sections 113 to 115 in accordance with the schedule signal, thereby regulating a transmission traffic flow volume from each user. However, the communication interface 121 may be a communication network-side interface, in which case communication with the shared bandwidth control device 200 and the billing management device 300 is performed through the communication network 100.

Note that the functions of the bandwidth communication device including the bandwidth control sections 113 to 115 and the control section 120 also can be implemented by executing programs stored in a memory, on a program-controlled processor such as a CPU (Central Processing Unit) (not shown).

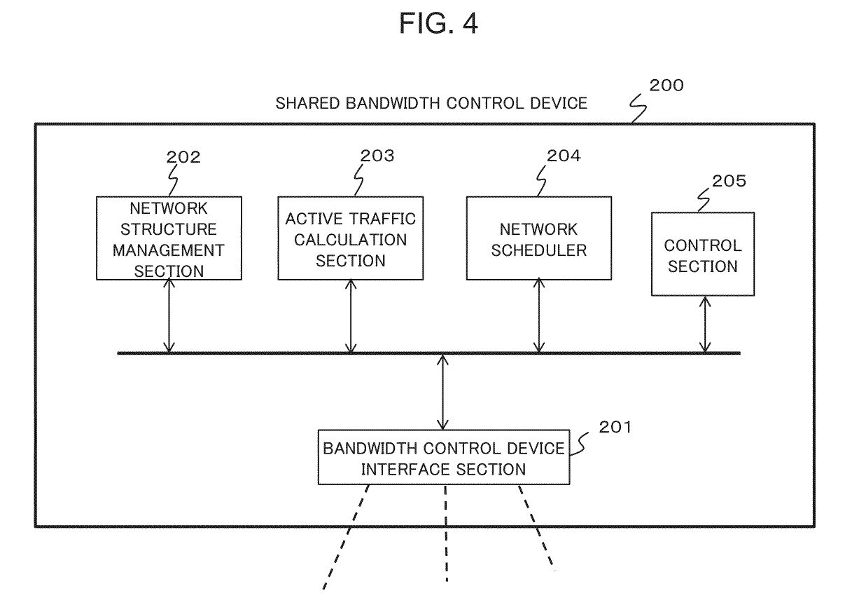

Referring to FIG. 4, the shared bandwidth control device 200 includes a bandwidth control device interface section 201 that connects to the bandwidth control devices 101.1 to 101.3 to acquire their states and control them. Moreover, the shared bandwidth control device 200 includes a network structure management section 202, an active traffic calculation section 203, and a network scheduler 204, whose operations are controlled by a control section 205.

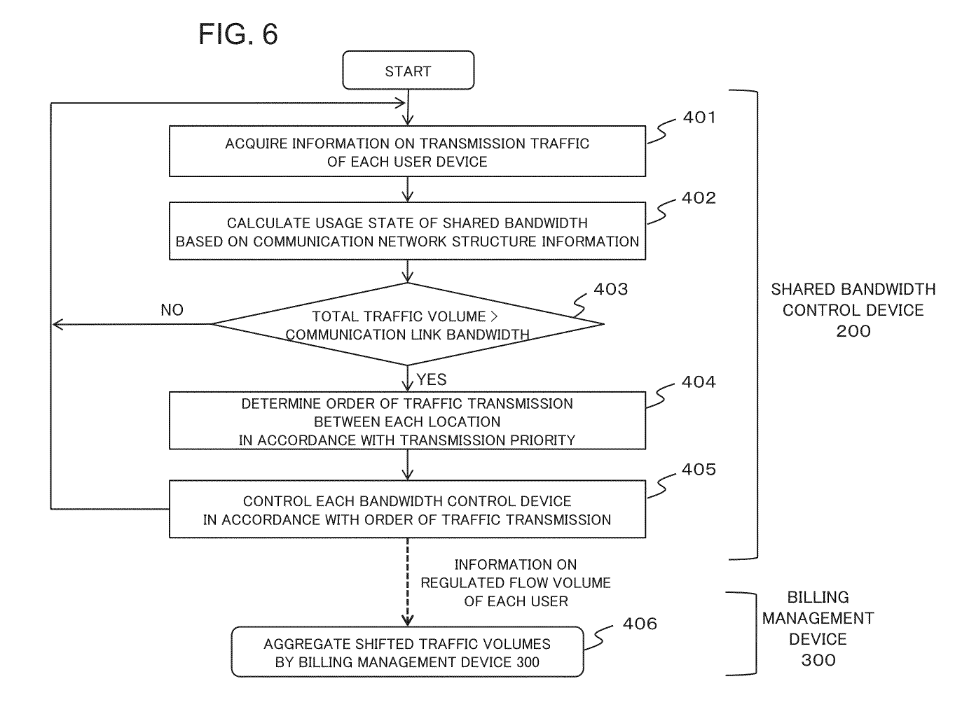

The network structure management section 202 manages a network structure of the communication network 100. The active traffic calculation section 203 calculates traffic volumes of individual user devices based on information collected by the bandwidth control device interface section 202. The network scheduler 204 regulates a traffic flow volume between user devices by using the traffic information calculated by the active traffic calculation section 203 and the network structure information managed by the network structure management section 202. Shared bandwidth control operation performed by the shared bandwidth control device 200 will be described later in detail with reference to FIG. 6.

Note that the functions of the network structure management section 202, the active traffic calculation section 203, the network scheduler 204, and the control section 205 also can be implemented by executing programs stored in a memory, on a program-controlled processor such as a CPU (Central Processing Unit) (not shown).

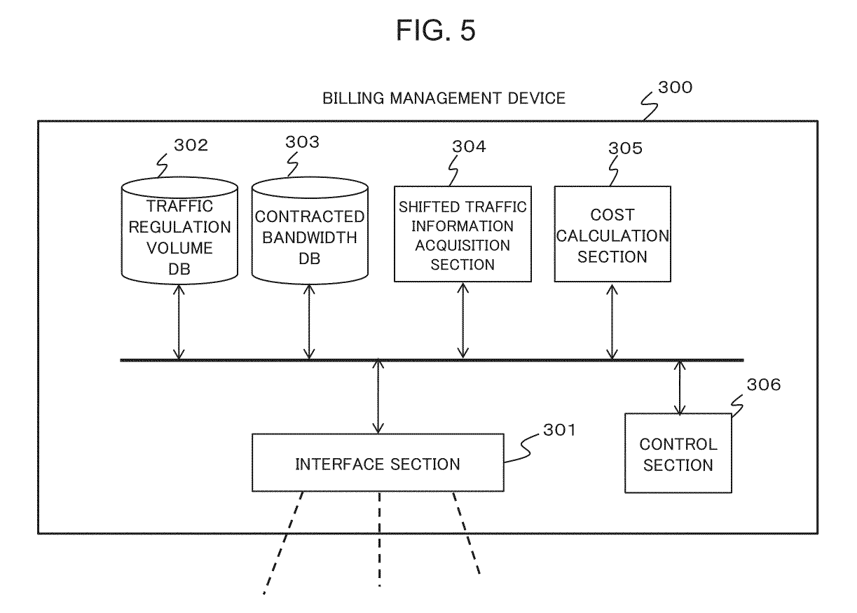

Referring to FIG. 5, the billing management device 300 includes an interface section 301 for connecting to the shared bandwidth control device 200 and the bandwidth control devices 101.1 to 101.3, a traffic regulation database 302, a contracted bandwidth database 303, a shifted traffic information acquisition section 304, and a cost calculation section 305, whose operations are controlled by a control section 306. The contracted bandwidth database 303 stores a contracted bandwidth for each user, which is set by a manager, together with the user's priority of traffic transmission.

The shifted traffic information acquisition section 304 acquires a regulated volume of a traffic flow volume made by the shared bandwidth control device 200 and stores it in the traffic regulation database 302. The cost calculation section 305 calculates a service charge for each user by using the information stored in the traffic regulation database 302 and the contracted bandwidth database 303.

Note that the functions of the shifted traffic information acquisition section 304, the cost calculation section 305, and the control section 306 also can be implemented by executing programs stored in a memory, on a program-controlled processor such as a CPU (Central Processing Unit) (not shown).

### 2.2) Shared Bandwidth Control

Referring to FIG. 6, first, the active traffic calculation section 203 of the shared bandwidth control device 200 acquires information on transmission traffic of each user device between the multiple locations, from the information collected through the bandwidth control device interface section 201 (Step 401). Concrete methods of acquiring the transmission traffic information are as follows.

Method a: Current traffic volumes actually monitored by the bandwidth control sections of each of the bandwidth control devices 101.1 to 101.3 are acquired through the bandwidth control device interface section 101.

Method b: History of the traffic volumes acquired by using the method a is stored, and transmission traffic volumes in near future are estimated based on movements in the past traffic volumes.

Method c: A sign that traffic will be transmitted from a user device is detected, and a traffic volume to be transmitted in the next moment is estimated. The sign that traffic will be transmitted is, for example, a request control packet to request image delivery or to request file transfer, and the traffic volume to be transmitted in the next moment can be calculated from a total amount of information requested to transmit (an image stream delivery rate and a file size).

Using the information on the transmission traffic volume of each user device between the multiple locations thus acquired and information on the structure of the communication network managed by the network structure management section 202, the network scheduler 204 calculates a usage state of the shared bandwidth of the communication links L1 to L3, from a total of the users' traffic volumes (Step 402).

Subsequently, the network scheduler 204 checks whether or not the total of the users' traffic volumes between the multiple locations exceeds the bandwidth of the communication links L1 to L3 (Step 403), and when it is not larger than the bandwidth of the communication links L1 to L3 (Step 403; NO), the control section 205 goes back to Step 401 of acquiring information on transmission traffic of the user devices to repeat Steps 401 to 402 as described above.

When the total of the users' traffic volumes exceeds the bandwidth of the communication links L1 to L3 (Step 403; YES), the network scheduler 204 determines order of track transmission between the multiple locations, in accordance with transmission priority from the users (Step 404). The network scheduler 204 sends a schedule signal indicating the determined order of transmission to the bandwidth control devices 101.1 to 101.3, and the control section 120 of each bandwidth control device controls the bandwidth control sections 113 to 115 in accordance with the order of transmission indicated by the schedule signal, thereby regulating a transmission traffic flow volume of each user (Step 405). The control section 205 repeats Steps 401 to 405 as described above.

For regulation of a transmission traffic flow volume by the bandwidth control sections 113 to 115, following two methods can be employed.

A first regulation method is a method in which an upper limit is placed on a usable bandwidth by using a traffic shaper. Thereby, flow control by TCP implemented on a user's application is operated, and the transmission traffic volume is decreased. However, traffic such as UDP traffic whose transmission is not controlled is discarded at the bandwidth control sections 113 to 115 if it exceeds the upper limit of the bandwidth.

A second regulation method is a method in which traffic on the communication links is monitored, and when traffic likely to exceed the total bandwidth of the communication links, a traffic restriction request is explicitly sent to a user device that is transmitting user traffic set for lower priority. Examples of this method include, for example, back pressure of Ethernet (registered trademark; hereinafter, the same applies.), PCN (Pre-congestion Notification) discussed at IETF (Internet Engineering Task Force), and the like. By using such a method, even at an application without flow control, control of a transmission traffic volume can be performed without discarding traffic.

Finally, based on a result of the control for flow volume regulation, the billing management device 300 aggregates shifted traffic volumes of each user and calculates a bill (Step 405).

### 2.3) Application Example

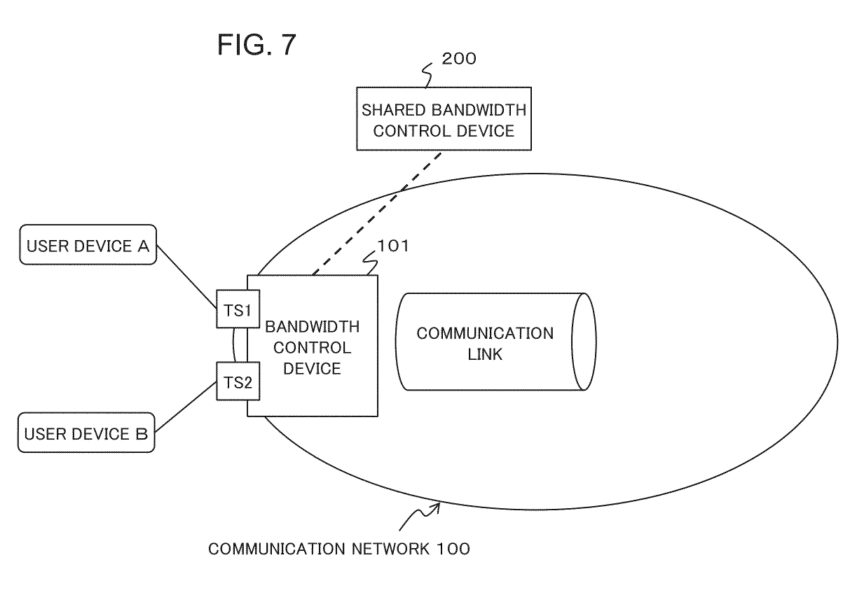

To describe specific effects of the above-described present example, a description will be given of a case where the present example is applied to a system shown in FIG. 7.

Referring to FIG. 7, it is assumed that a user device A and a user device B are connected to a bandwidth control device 101 located at an end point of the communication network 100, and that respective traffic flow volumes are regulated by traffic shapers TS1 and TS2 respectively, in accordance with the shared bandwidth control according to the present example.

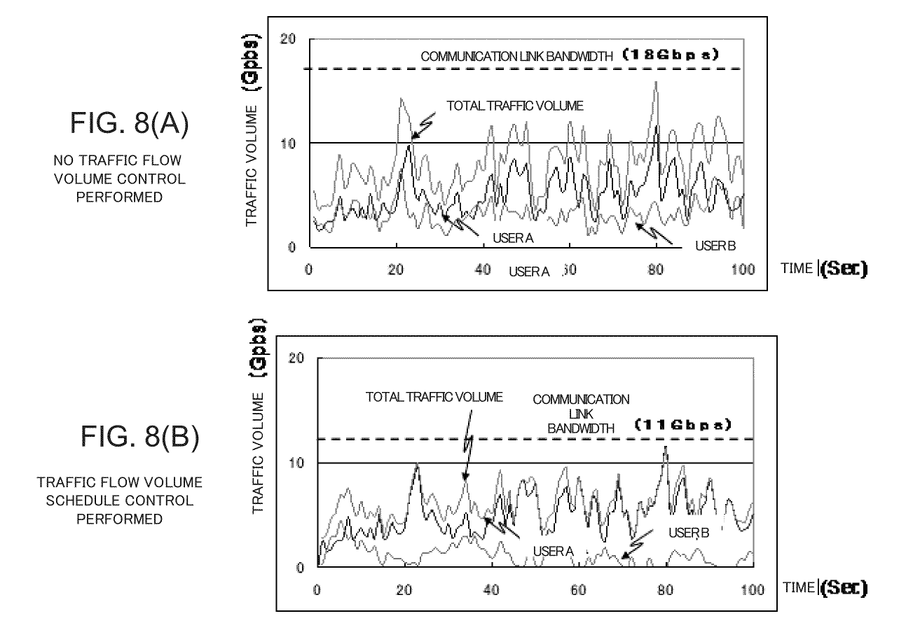

FIG. 8(A) shows a comparative example, depicting time-series traffic volumes on a communication link in a case where the traffic flow volume control according to the present example is not performed. It can be seen that since the traffic flow volumes of the users A and B are not restricted, a total communication bandwidth of 18 Gbps or more needs to be secured as a communication link in order to accommodate burst traffic of the two users. Here, assuming that a communication link of 18 Gbps is secured, a period is very short during which 50% or more of the bandwidth of the communication link is used, and therefore the communication link has very low usage efficiency.

On the other hand, FIG. 8(B) depicts time-series traffic volumes in a case where the traffic flow volume schedule control according to the present example is applied. Here, it is assumed that traffic transmitted by the user A has priority over traffic transmitted by the user B. In this case, since the traffic volume of the user B is restricted when the user A transmits burst traffic, it is possible to restrict the maximum total traffic volume to 11 Gbps or smaller. Assuming that a communication link of 11 Gbps is secured, it can be seen that the total bandwidth of the communication link most of the time, and therefore the usage efficiency of the bandwidth of the communication link is high.

### 2.4) Effects

As described above, by applying the shared bandwidth control according to the present example, it is possible to restrict the total traffic volume to the upper limit of the shared bandwidth of the communication link or smaller by controlling the bandwidth control devices at the multiple locations only, whereby it is possible to ensure communication quality and also to enhance network usage efficiency. As described above, a plurality of users share a bandwidth, and burst traffic transmission is controlled among them, whereby it is possible for each user to transmit burst traffic at lower communication cost. Moreover, since high usage rate of the communication link can be kept, it is possible to reduce capital spending of a communication service provider. For example, when there is an available bandwidth on a communication link, or when there is lower-priority traffic of another user, a user using a communication network can transmit burst traffic only by controlling a bandwidth control device located at an end point of a communication network. The reason is that any one of the users can obtain a right to transmit burst traffic, based on traffic usage rate in the network, and on a result of negotiation with the other user as to which one's traffic is prioritized. At that time, a user who has refrained transmission shall receive the merit that the communication cost is reduced.

### 3. Billing Management

The example in FIG. 8 shows that the transmission traffic of the user B is restricted for the user A. This restricted traffic volume (shifted traffic volume) is measured by the billing management device 300, and a charge is calculated by using a cost function defined by each communication service provider.

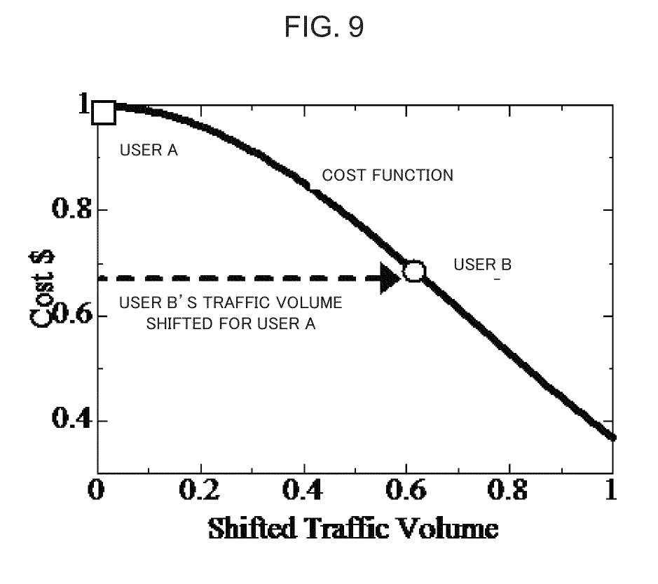

For example, if the cost function is as shown in FIG. 9, the user A pays a charge as contracted beforehand to a communication service provider because no flow volume regulation is performed on the user A, and the user B pays a charge that is about 70% of a contracted price because 60% of traffic originally planned to be transmitted in real-time is regulated in terms of flow volume. In this manner, the regulated flow volume and the usage charge are configured to have correlation, whereby it is possible to efficiently use limited communication resources.

Note that in the above-described example, shown is a case where traffic of the user A is always prioritized, but it is also possible that detailed priority classes are defined among respective packet traffic to be transmitted by the users A and B, and transmission schedule control is performed on a traffic class basis.

### 4. Modification Examples

Although in the above-described exemplary embodiment and example, described is a mode in which bandwidth control devices are deployed at end points of a communication network, the present invention is not limited to this, and bandwidth control devices may be deployed within user devices in a distributed manner.

Moreover, the present invention can be applied to such uses as a control system and a billing system for a wide-area communication network in which a plurality of users share a bandwidth and efficiently use resources of a communication service provider while low-cost communication can be achieved. Further, the present invention also can be applied to such uses as a control system and a billing system of a virtual network operator that is a provider owning no physical resources and leasing resources from a communication service provider to provide low-cost communication services.

### 5. Additional Statements

Part or all of the above-described exemplary embodiments also can be stated as in, but is not limited to, the following additional statements.

### Additional Statement 1

A shared bandwidth control method in a bandwidth sharing network in which a plurality of user groups share network resources through a plurality of locations, characterized in that:

traffic acquisition means acquires user traffic transmission volumes flowing from the respective locations into the bandwidth sharing network; and

scheduling means regulates a user traffic transmission volume flowing into the bandwidth sharing network so that a total of the user traffic transmission volumes will not exceed a total bandwidth pre-assigned to the plurality of user groups in the bandwidth sharing network.

### Additional Statement 2

The shared bandwidth control method according to additional statement 1, characterized in that the traffic acquisition means estimates the user traffic transmission volumes based on information regarding user traffic monitored by bandwidth control devices provided respectively at the plurality of locations.

### Additional Statement 3

The shared bandwidth control method according to additional statement 1 or 2, characterized in that the scheduling means schedules order of transmission in accordance with transmission priority of user traffic.

### Additional Statement 4

A shared bandwidth control device in a bandwidth sharing network in which a plurality of user groups share network resources through a plurality of locations, characterized by comprising:

traffic acquisition means for acquiring user traffic transmission volumes flowing from the respective locations into the bandwidth sharing network; and

scheduling means for regulating a user traffic transmission volume flowing into the bandwidth sharing network so that a total of the user traffic transmission volumes will not exceed a total bandwidth pre-assigned to the plurality of user groups in the bandwidth sharing network.

### Additional Statement 5

The shared bandwidth control device according to additional statement 4, characterized in that the traffic acquisition means estimates the user traffic transmission volumes based on information regarding user traffic monitored by bandwidth control devices provided respectively at the plurality of locations.

### Additional Statement 6

The shared bandwidth control device according to additional statement 5 or 6, characterized in that the scheduling means schedules order of transmission in accordance with transmission priority of user traffic.

### Additional Statement 7

A shared bandwidth control system in a bandwidth sharing network in which a plurality of user groups share network resources through a plurality of locations, characterized by comprising:

bandwidth control devices that are provided respectively at the plurality of locations of the bandwidth sharing network and perform monitoring of a traffic volume of each user and bandwidth control; and

a shared bandwidth control device that can communicate with each of the bandwidth control devices,

wherein the shared bandwidth control device comprises:

traffic acquisition means for acquiring user traffic transmission volumes flowing from the respective bandwidth control devices into the bandwidth sharing network; and

scheduling means for regulating a user traffic transmission volume flowing into the bandwidth sharing network so that a total of the user traffic transmission volumes will not exceed a total bandwidth pre-assigned to the plurality of users in the bandwidth sharing network.

### Additional Statement 8

The shared bandwidth control system according to additional statement 7, characterized in that the traffic acquisition means estimates the user traffic transmission volumes based on information regarding user traffic monitored by the bandwidth control devices provided respectively at the plurality of locations.

### Additional Statement 9

The shared bandwidth control system according to additional statement 7 or 8, characterized in that the scheduling means schedules order of transmission in accordance with transmission priority of user traffic.

### Additional Statement 10

The shared bandwidth control system according to any one of additional statements 7 to 9, characterized in that the bandwidth sharing network is a VPN (virtual private network).

### Additional Statement 11

A program causing a program-controlled processor to function as a shared bandwidth control device in a bandwidth sharing network in which a plurality of user groups share network resources through a plurality of locations, characterized by causing the program-controlled processor to implement:

a traffic acquisition function of acquiring user traffic transmission volumes flowing from the respective locations into the bandwidth sharing network; and

a scheduling function of regulating a user traffic transmission volume flowing into the bandwidth sharing network so that a total of the user traffic transmission volumes will not exceed a total bandwidth pre-assigned to the plurality of user groups in the bandwidth sharing network.

### Additional Statement 12

The program according to additional statement 11, characterized in that the traffic acquisition function estimates the user traffic transmission volumes based on information regarding user traffic monitored by bandwidth control devices provided respectively at the plurality of locations.

### Additional Statement 13

The program according to additional statement 11 or 12, characterized in that the scheduling function schedules order of transmission in accordance with transmission priority of user traffic.

### Additional Statement 14

The shared bandwidth control system according to any one of additional statements 7 to 10, characterized by further comprising a billing management device that changes an amount to bill a user, depending on a regulated traffic transmission volume of the user.

### INDUSTRIAL APPLICABILITY

The present invention is applicable to a traffic control system for a wide-area communication network.

### REFERENCE SIGNS LIST

10 Intra-user-groups bandwidth sharing network
11.1-11.4 Bandwidth control device
12 Shared bandwidth control device
G1-G4 Bandwidth sharing user group
T1-T4 Traffic volume information
C1-C4 Shared bandwidth control signal
100 Communication network
101.1-101.3 Bandwidth control device
110-112 User-side communication interface
113-115 Bandwidth control section
116 Packet switch
117-119 Communication network-side interface
120 Control section
121 Communication interface
102 Communication device
200 Shared bandwidth control device
201 Bandwidth control device interface section
202 Network structure management section
203 Active traffic calculation section
204 Network scheduler
205 Control section
300 Billing management device
301 Interface section
302 Traffic regulation volume database
303 Contracted bandwidth database
304 Shifted traffic information acquisition section
305 Cost calculation section
306 Control section
L1-L3 Communication link
TS1, TS2 Traffic shaper

What is claimed is:

1-10. (canceled)

11. A shared bandwidth control method in a bandwidth sharing network in which a plurality of user groups share network resources through a plurality of locations, comprising:
acquiring user traffic transmission volumes flowing from the respective locations into the bandwidth sharing network; and
regulating a user traffic transmission volume flowing into the bandwidth sharing network so that a total of the user traffic transmission volumes will not exceed a total bandwidth previously assigned to the plurality of user groups in the bandwidth sharing network.

12. The shared bandwidth control method according to claim 11, wherein the user traffic transmission volumes are estimated based on information regarding user traffic monitored by bandwidth control devices provided respectively at the plurality of locations.

13. The shared bandwidth control method according to claim 11, wherein the user traffic transmission volume is regulated by scheduling order of transmission in accordance with transmission priority of user traffic.

14. The shared bandwidth control method according to claim 12, wherein the user traffic transmission volume is regulated by scheduling order of transmission in accordance with transmission priority of user traffic.

15. A shared bandwidth control device in a bandwidth sharing network in which a plurality of user groups share network resources through a plurality of locations, comprising:
a traffic acquisition section for acquiring user traffic transmission volumes flowing from the respective locations into the bandwidth sharing network; and
a scheduler for regulating a user traffic transmission volume flowing into the bandwidth sharing network so that a total of the user traffic transmission volumes will not exceed a total bandwidth previously assigned to the plurality of user groups in the bandwidth sharing network.

16. The shared bandwidth control device according to claim 15, wherein the traffic acquisition section estimates the user traffic transmission volumes based on information regarding user traffic monitored by bandwidth control devices provided respectively at the plurality of locations.

17. The shared bandwidth control device according to claim 15, wherein the scheduler schedules order of transmission in accordance with transmission priority of user traffic.

18. The shared bandwidth control device according to claim 16, wherein the scheduler schedules order of transmission in accordance with transmission priority of user traffic.

19. A shared bandwidth control system in a bandwidth sharing network in which a plurality of user groups share network resources through a plurality of locations, comprising:
bandwidth control devices that are provided respectively at the plurality of locations of the bandwidth sharing network, wherein each of the bandwidth control devices performs monitoring of a traffic volume of each user and bandwidth control; and
a shared bandwidth control device that can communicate with each of the bandwidth control devices,
wherein the shared bandwidth control device comprises:
a traffic acquisition section for acquiring user traffic transmission volumes flowing from the respective bandwidth control devices into the bandwidth sharing network; and
a scheduler for regulating a user traffic transmission volume flowing into the bandwidth sharing network so that a total of the user traffic transmission volumes will not exceed a total bandwidth previously assigned to the plurality of users in the bandwidth sharing network.

20. The shared bandwidth control system according to claim 19, wherein the traffic acquisition section estimates the user traffic transmission volumes based on information regarding user traffic monitored by bandwidth control devices provided respectively at the plurality of locations.

21. The shared bandwidth control system according to claim 19, wherein the scheduler schedules order of transmission in accordance with transmission priority of user traffic.

22. The shared bandwidth control system according to claim 20, wherein the scheduler schedules order of transmission in accordance with transmission priority of user traffic.

23. The shared bandwidth control system according to claim 19, wherein the bandwidth sharing network is a VPN (virtual private network).
